(19) United States
(12) Patent Application Publication
(10) Pub. No.: US 2010/0017466 A1
(43) Pub. Date: Jan. 21, 2010

(54) SYSTEM AND METHOD FOR DYNAMIC PROCESSING OF MEASUREMENT METRICS AND TAGGING MEASUREMENT METRICS

(76) Inventor: Douglas Trauner, Corte Madera, CA (US)

Correspondence Address: DERGOSITS & NOAH LLP, Three Embarcadero Center, Suite 410, SAN FRANCISCO, CA, 94111, US

(21) Appl. No.: 12/486,716

(22) Filed: Jun. 17, 2009

Related U.S. Application Data
(60) Provisional application No. 61/073,306, filed on Jun. 17, 2008.
(60) Provisional application No. 61/092,298, filed on Aug. 27, 2008.

(51) Int. Cl. G06F 15/16

(52) U.S. Cl. 709/203

(57) ABSTRACT

A computer system is dynamically configurable for inputting, storing, processing and outputting metric data and tag data. The system includes a server and client computers that each has an input device, storage device, processing device and output device. The input, processing and output are each controlled by a dynamically configurable processing logic based upon one or more factors including: input measurement, measurement subject, processing method, application, industry, region, or a user as determined by configuration, preferences, properties or values

### CROSS REFERENCE TO RELATED APPLICATIONS

This application claims priority to U.S. Patent Application No. 61/073,306, SYSTEM AND METHOD FOR DYNAMIC CONFIGURATION OF MEASUREMENT METRICS, filed Jun. 17, 2008 and U.S. Patent Application No. 61/092,298, SYSTEM AND METHOD FOR TAGGING MEDIA WITH MEASUREMENT METRICS. The entire contents of these US patent applications are hereby incorporated by reference.

### FIELD OF INVENTION

This invention relates generally to an improved computer system for the universal configuration and management of measurement metrics about one or more measurement subjects. The invention is a system and method for the input, storage and output of measurement metric data. The system provides a method for dynamically defining measurement metrics based upon but not limited to industry standards, user preferences, subject data, storage definitions, data conversions, and formatting for graphical interface, printed output and formatted data transmission.

### BACKGROUND

In the past there have been different methods for converting units for the quantification of data. Measurement and reporting applications are typically focused on well defined measurement types or modules that include coded rules for the preferred storage measurement units and the ability to support a few well defined user preferences such as the “English” or “Metric” system of measures. The measurements can be applied to a wide variety of subject matter. For example, an application or service records the distances travelled by subjects during a bicycle ride or drive in a car. The user preference is for the English system and the user is prompted to enter the travelled distances in miles. An entry of 5.5 miles is submitted and the application may store the data in memory as 8.851 kilometers. When the entered data is then later requested, it is reported to the user as 5.5 miles by converting the units of measurement back from kilometers back to miles. In another example, if the user inputs a travelled distance as 5¼ miles, a format conversion may convert fractional inputs into correct values as well resulting in the storage of the data as 5.25 miles.

The same application can also be used to track much shorter distances. For example, hair length and growth rate can be tracked. A user in the United States may input the hair length in units of inches. The system would then convert the measurement data from inches to centimeters and store the measurements in centimeters. When a report is requested, the system would convert the centimeter units back to inches for user output and reporting. If a user were to change their unit preference to the metric system all measurements would be entered, stored and reported in metric units. A standard measurement can be defined for a measurement type and all measurements can be converted to the standard. For example all length measurements can be stored as meters. This method may work well for measurements within a few orders of magnitude, but becomes ineffective when required to measure vastly different measurements such as body weight measured in kilograms (kg) and drug active ingredients measured in micrograms (μg) per dose or length measured in nanometers and astronomical units.

In the prior art, tags have been used with digital data. A tag is a non-hierarchical keyword or term assigned or tagged to a piece of stored digital information such as an internet bookmark, digital image, or computer file on a web site. The tags are like categories that allow content on a web site, such as pictures, videos, and articles to describe the information. Tags allow the information to be found again by browsing or searching. By organizing the web site content by categories or tags, a user can more easily navigate through the web site and search engine spiders are informed how to index the web site. Tags are chosen informally by the information creator or by the viewers of the information, depending upon the configuration of the system. Information can be tagged with multiple tags that describe the content.

An example of tagging can be a web page hosted on a web server or blog server which supports tagging might have the tags “Baseball”, “Yankees”, “Tickets”, “Away Games”, and “Discounts.” Typically, the server displays the tags in a list on the web page, with each tag displayed as a web link. By clicking on the tags, a user can quickly locate all pages which have been associated with a tag term. If the server supports tag searching, a reader would be able to find all pages that use a particular set of tags, such as “Yankees” and “Tickets”.

A problem with existing tags is that they are text based and can describe the item in a random manner depending upon the user's sorting methodology. Although the tag is useful for sorting and finding information, they do not provide any additional useful data about the information. What is needed is an improved system and method for tracking metrics that defines and manages measurement metrics and incorporates an improved method for adding tags of metric data to information that can be used for more than sorting and finding information.

### SUMMARY OF THE INVENTION

The system provides a system and method for tracking and reporting metric data. In a preferred embodiment, the system includes a server computer and client computers that are in communication with each other through a network. The server computer includes a data storage device and a computer tracking program for receiving input metric data and converting the metric data into reports. The client computers each include an input device and a visual display.

In a preferred embodiment, the tracking program is web server program that is accessible to the users of the client computers. A graphical user interface for the computer tracking program is displayed on client computers and metric data for the user can be input through the interface. The tracking program can be used for tracking the user data over time and producing reports based upon the tracked data. The user can configure the computer program to track virtually any aspect of his or her life. For example, tracker data can be generally grouped into health condition, mental condition, medication and activity. Within each of these general groups, there are numerous subgroups. For example, health condition may include weight, energy level, illness, surgery, medical condition, symptoms, etc. Mental condition may include: job satisfaction, mood, happiness, anxiety, depression, etc. Medication can include all prescription and non-prescription medications. Activity data may include, exercise, meditation, sex, sleep, wake ups during sleep, smoking, TV viewing, and other activities. In other embodiments, the tracking program can be used to track other metric data such as: finances, sports statistics, world events, or any other quantifiable metric.

When a user first uses the tracking program, a secure communications connection between the client and server computer is established and the user will input personal information and select the categories of data to be tracked. Once the trackers are selected, the user can begin inputting data which is stored for the user. The user interface of the tracking program can adjust the units of measurement to any scale desired by the user, easily defining and managing measurement metrics, units of measurement, data conversions, storage definitions and output formatting definitions for an input measurement or series of measurements relating to a measurement subject for input, storage and formatted data output. The inventive system provides numerous benefits over prior art unit conversion systems. The inventive system maintains the data integrity and report data reflecting the users' changing requirements. These changing requirements can include user changes, application changes and changes in industry preferences.

The inventive system is able to cope with the changing industrial standards of any industry. For example, the international unit for blood glucose concentration measurements is millimole per liter (mmol/L) although the United States still uses milligrams per deciliter (mg/dL). The increasing availability of measurement devices that support both mg/dl and mmol/l may indicate a possible future transition toward mmol/L in the United States. Since the inventive system stores is designed to convert data into any unit of measurement, the use of data form the inventive system will not be impacted by the switch to the mmol/L units of measurement. Thus, transition of a regional preference should not impact the ability of the inventive system to report against historical data.

The inventive system also performs storage optimization. Measurements shall be able to be stored as required for a given measurement or unit. For example, length measurements as different as nanometers and astronomical unit can be stored as in their respective units if desired rather than being converted to meters or other standard units. In another example, a blood pressure measurement of 120/80 can be stored as a compound real value of 1200.800 if desired, an integer of 1200800, or unique values of 120.0 and 80.0.

The inventive system also performs personalized input and output functions. Support shall be provided for simple functions dependent upon only an input value or complex calculations that may have dependencies upon various additional inputs including, but not limited to, user preferences, subject values, unit, and/or metric being calculated. Example of complex calculations include, converting concentrations from milligrams/deciliter (mg/dl) to millimoles/liter (mmol/l) which requires the molecular weight of the diluted agent. This type of calculation may be necessary for metrics as blood cholesterol levels.

Another aspect of the present invention is the ability to process data in any format. A single data value can include multiple values which can be extracted by the inventive system. For example, Blood pressure can be entered and stored as “120/80.” During processing, the system can recognize the format and meaning of the values and extract the two measurements. In this example, the single numeric value can be converted to two data reading for systolic and diastolic pressures. This data can be stored as one hybrid value or reformatted and stored as 120/180. The system can similarly provide the output data as a single or two values.

The inventive system can also perform unit optimization. In an embodiment, the inventive system can enable or disable the optimization of output units to best reflect the measurement value. Example includes 0.005 gallons could be better displayed as 1¼ tablespoon. Examples of disabled optimization include 500 mg of a medicine dosage, 2000 mg of sodium for nutritional measurement.

Input and output formatting are also performed by the inventive system. The present invention provides an adaptable system for tracking subject measurements for an infinite range of subject matter, including but not limited to: health, exercise, fitness, interest, relationships, employment, finance, entertainment, education, scientific research, social behavior, etc. over a range of dimensions including but not limited to time, distance, geography, mass, currency, etc. The processing of the data can include conversion of some or all of the data into: graphical representations, text, audio, multi-media, etc. The results of the tracking can also have a wide variety of uses, including: goal tracking, health monitoring, social networking, analysis, scientific surveys, medical research, etc. The inventive system also provides support for various scheme of data distribution. Data can be transmitted in a one to one, one to many and many to one communications paths. An example of one to one data transmission can be medical records can be recorded by a patient and transmitted to a physician who can analyze the patient data and prepare a report based upon the data. The completed report can then be transmitted from the physician to the patient. An example of many to one data transmission can be a fitness or athletic group can have members who each transmit performance data to a coach. The coach can analyze the data and prepare a report of the group. The report can then be transmitted from one to many, when the report is transmitted from the coach to the athletic group.

The system also provides a method for applying tags to the stored information. The tags can enhance the stored data and may provide additional information which can be used to generate reports. When a user wishes to add data to stored information, he or she can associate a tag with the stored information. In the past, tags have been text based category data that allows the user to sort through information on a web site such as a blog. The information tagged with the category text will be found by a search or index. Thus, the tagged data is available or presented to a user when the user accesses the tag category. The present invention builds upon this concept by adding metric tag data that can be used for processing of the information and being able to apply these tags to any type of digital media including: images, movies, documents, web pages, etc.

In an embodiment, the tags can be applied to the stored information through a user interface. The information may be tagged with a first tag which provides a category or subject matter. Additional tags can provide metric information for the subject matter. The metric data allows the information to be processed and presented in a more useful or contextual manner. The metric tag data can be obtained from any source.

For example, in an embodiment, the user will access stored information which can be a series of photographs. A user can access the photographs and tag them with the subject matter and metric data. In an embodiment, the photo is displayed on a portion of a user interface and the user interface may also have another area where the user can input the category and metric tags. This process can be repeated for all of the photos that are in the category. With the photos tagged, the inventive system can display or present the photos based upon the metric information.

After the information has been tagged, metric data tags can be processed and the information displayed in various different ways based upon the metric tag data. In other embodiments, the user interface may have a button that allows the tag controls to be accessed. Because the tags are not necessarily only alpha numeric data, the inventive system may detect the type of data being applied user may have to define. For example, the tags applied in the inventive system can include: text, pictures, video, audio and other graphical data. The inventive system may detect the type of file based upon the detected file type or name. This information can be stored on the computer or input through a memory device or an input device.

The present invention is primarily directed towards the processing of metric information. The metric data can include the units of measurement, data conversions, storage definitions and output formatting definitions for an input measurement or series of measurements relating to a measurement subject for input, storage and formatted data output. In contrast, non-metric data can include all other information that is not a unit of measurement, data conversion, storage definition or output format definition for an input measurement. Examples of non-metric data can include photos, audio, video, descriptive and non-metric text, etc.

In the preferred embodiment, the inventive system is directed towards the tagging of information with metric tags. The objects or data being tagged can be metric or non-metric information. For example, the items can be a series of photographs of a child can be non-metric information. When each photo is presented, the user can tag the photo with the data information and the inventive system can utilize the metric tag data to perform a quantitative analysis of the subject such as a growth chart. In a graphical representation of a child's growth, a horizontal axis can represent the age of the child and each of the photos can be displayed at the corresponding age. If a second metric such as height is input, the inventive system can create an X-Y graph of the change in height over time together with a photo of the subject.

With the metric time tag data, the inventive system can provide a time control for the age of the child and by inputting an age, the corresponding photo for that time can be displayed. Thus, the metric tag data can be used to obtain the proper photo of an individual based upon the input age. Similar time tagging of non-metric information can be applied to diets, exercise programs, etc. The metric tags can include size, weight, time, caloric intake, blood pressure, etc.

While the information has been described as photographs, other non-metric media formats can also be tagged. Rather than a photo over time, the media can be a video of the subject. For example, the video can be a swimming race and the metric tag can be the time for the swimming race. By comparing the subject's videos for fast and slow times, the user can visualize variations in technique and might be able to quantify the changes in speed based upon different techniques.

In addition to visual data, the non-metric information can be audio, text, documents, etc. that are related to the subject being studied. An example of audio or text information can be related to the diaries or accounts of life events. A user can record such things as: activities, preparation, routines, exams, feelings, mood, and emotions such as: sorrow, joy, satisfaction, anger, hunger, pain, etc. These human reactions are difficult to quantify but can be recorded on a scale between two extreme conditions. For example, mood can range from extreme sorrow to extreme elation with intermediate feelings such as miserable, sad, happy, joyful, etc in between these extremes. In an embodiment, the input value can be a user interface that has a slider the moves on a scale between these mood descriptions. Other descriptions can be used for other types of tracking subject matter. Alternatively or in addition to the scaled input, an audio recording, text or photograph tag can be used to express a tracked subject matter. This information can then be tagged with metric data such as a date/time, location, temperature, weather, altitude, GPS coordinates, caloric intake or other quantifiable data. In this embodiment, the tag data may come from measurement devices which output or stream the metric data which is read or sampled by the metric input device. The inventive system can be used to apply metric tags to recorded information. This information can be useful when applied to activities such as personal exercise movement such as gym workouts, sports such as hiking, running, biking, skiing, kite boarding, or travels.

The present invention provides an adaptable system for tracking subject measurements for an infinite range of subject matter, including but not limited to: health, exercise, fitness, interest, relationships, employment, finance, entertainment, education, scientific research, social behavior, etc. over a range of dimensions including but not limited to time, distance, geography, mass, currency, etc. The processing of the information can include conversion of some or all of the data into: graphical representations, text, audio, multi-media, etc. The results of the tracking can also have a wide variety of uses, including: goal tracking, health monitoring, social networking, analysis, scientific surveys, medical research, etc. The inventive system also provides support for various scheme of data distribution. Data can be transmitted in a one to one, one to many and many to one communications paths.

As an example of a suitable application, a user's thoughts, physical and emotional can be recorded in text or audio commentary during a mountain climb. The user can then tag the recorded data with. metric data such as GPS coordinates which can be overlaid on a topographical map. The recorded commentary can then be associated with the metric data. This information can be useful in determining various parameters for the user such as physical limits. At what ambient conditions does the user begin to feel uncomfortable? The data may indicate the minimum comfortable temperature, maximum altitude, maximum distance that can comfortably be traveled, etc. In many cases, the mental and physical condition may be predictable based upon a combination of metric data.

The inventive system can also be used to track the health of an individual or group. For example, the metric tags can be information regarding nutrition and medication as applied to health. The user can provide subjective data (feelings and mood) and objective data (heart rate, blood pressure and weight) regarding the user's health and well being and the medicine and nutritional intakes can be the metric tags. By correlating the user information with the metric data, the inventive system can provide a graphical relationship between the user's health and the medication and nutritional intakes of the user. This can be useful in determining the most effective diet or treatment for a user.

In other embodiments, the item can be the metric data and the tag can be an object. The examples above are items that are metric data. The metric item data may be converted to various different units of measurement but the tags applied to the item metric data may not be altered. In other embodiments, the items may be non-metric data and the tags may be metric data. In this embodiment, the metric tag data can be converted in any manner described above.

### BRIEF DESCRIPTION OF THE DRAWINGS

FIG. 1 illustrates a diagram of a client server network for the inventive system;

FIG. 2 illustrates a diagram of an embodiment of the data input, storage and output systems;

FIG. 3 illustrates a diagram of an embodiment of the data output system;

FIG. 4 illustrates a diagram of an embodiment of the input format processing;

FIG. 5 illustrates a diagram of an embodiment of the processor processing;

FIG. 6 illustrates a diagram of an embodiment of the output format processing;

FIG. 7 illustrates a diagram of a user interface used to provide tag data;

FIG. 8a-8d illustrate photo information and tags applied to the metric data;

FIG. 9 illustrates a graphical output that includes the photos tagged to the data;

FIG. 10 illustrates a user interface used to input metric data;

FIG. 11 illustrates a detailed display of nutritional components based upon a variable volume; and

FIG. 12 illustrates a time based report that incorporates multiple tracked data and tags.

### DETAILED DESCRIPTION

The present invention is directed towards a configurable measurement metric input/storage/output system. Reference will now be made in detail to preferred embodiments of the invention, so as to enable a person skilled in the art to make and use the invention in the context of a particular application. It is understood that such embodiments are not intended to limit the invention to one preferred embodiment or application. On the contrary, the invention is intended to cover alternatives, modifications, and equivalents. Various modifications to the present invention will be readily apparent to one of ordinary sill in the art, and can be made to the described embodiment within the spirit and scope of the invention as defined by the appended claims.

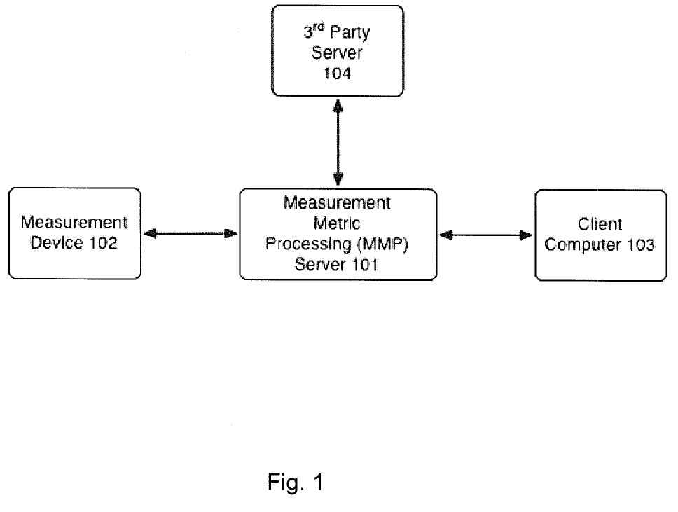

In one preferred embodiment, a server runs software that provides a web site or data service that is accessible through a network such as the Internet by client computers. With reference to FIG. 1, the Measurement Metric Processing (MMP) Server 101 comprises hardware specifically designed for the invention, or a combination of hardware and computer software. The software can be a component bought off the shelf, a component specially designed for a particular home or office, a plug-in to a software developer's kit, or part of a larger proprietary system, among other embodiments. The software of the Server 101 is typically written in C, C++, Java, PHP, Ruby or other programming languages. The server 101 is designed to have a robust and flexible interface that makes it easy for developers to develop input and peripheral devices that operate across a network or locally with measurement devices 102, client computers 103 and 3rd party servers 104.

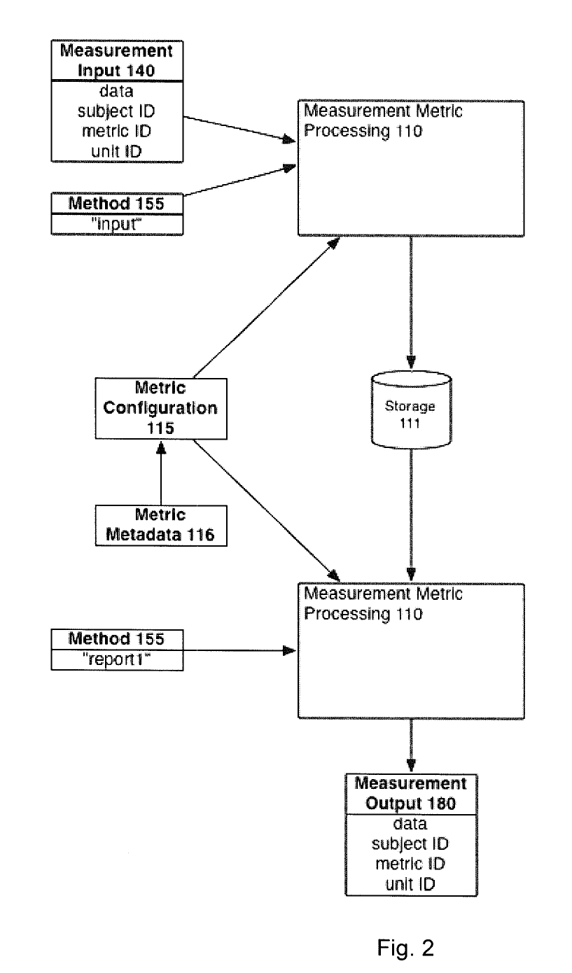

With reference to FIG. 2, the information and tags can be forwarded to a metric processing object 110. In addition to the measurement input 140, a method 155 is also input into the metric processing object 110. Metric metadata 116 can be used to determine a metric configuration 115 which is forwarded to the measurement metric processing 110. The processing of the measurement input 140 by a measurement metric processing object 110 is defined by the input method 155 and the metric configuration 115.

After the measurement input 140 has been processed by the measurement metric processing 110, the processed data is stored in the storage device 111 which can be a memory device. The storage device 111 can be any type of computer memory including random access memory, tapes, magnetic discs and optical discs. The memory can be coupled to any individual client or server computer on the network or the memory can be distributed amongst multiple computers. For example, personal information may be stored on a user's client computer while public information can be stored on any other computer.

When a user wishes to access the data, the storage device 111 is accessed and the measurement data is retrieved from the storage device 111 as input for a measurement metric processing object 110. The data request can define a method 155 for the measurement metric processing 110 such as “report1” or any other type of data request. The measurement metric processing 110 performs the required data processing and outputs the measurement output 180 which includes the processed data and may also include the subject ID, metric ID and unit ID.

The measurement input 140, measurement output 180, the method input 155, metric metadata 116 and metric configuration 115 can be performed through a client computer. The measurement metric processing 110 can be performed through a client computer or a server computer. Similarly, the storage device 111 can be coupled to a client computer or a server computer.

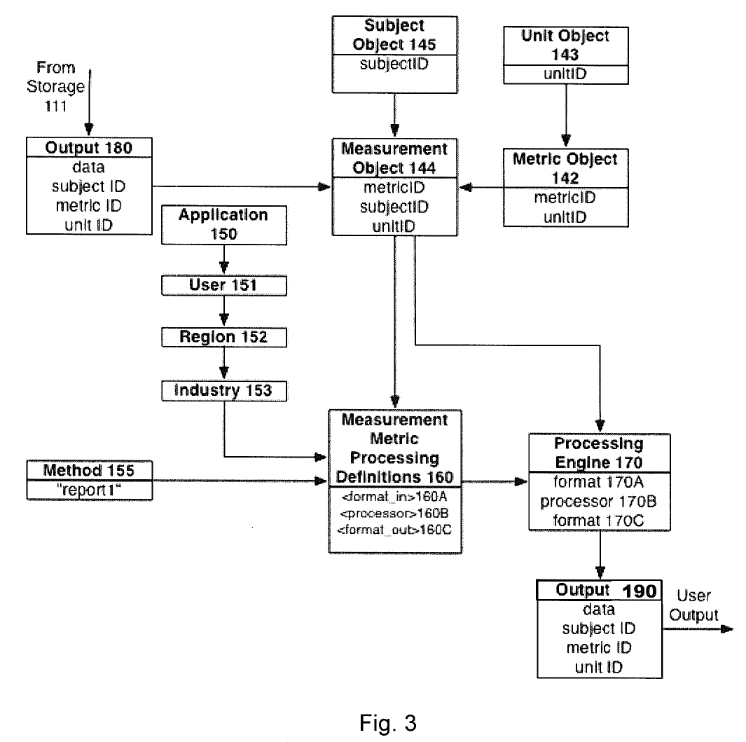

With reference to FIG. 3, a block diagram of the output 180 data retrieval from the storage device 111 in the inventive system is disclosed. The data 180 output can be requested by a client computer and transmitted from the storage device 111. The output data 180 can be associated with a subject object 145, a metric object 142, and unit object 143 to create a measurement object 144. Dynamic or static measurement metric processing definitions 160 can be built based upon but not limited to a variety of definition inputs objects such as an application 150, user 151, region 152, industry 153, subject, 145, measurement 144, metric 142, and unit objects as well as the processing method 155 to create a final measurement metric processing definition 160. In addition to explicit metric processing definitions, measurement processing definitions may be dependent upon defined values/properties of associated objects. Completed measurement processing definitions 160 are input with the measurement object 144 to the processing engine 170 to calculate and format an output object/record/data 190.

The measurement metric processing definition 160 can consist of format_in 160A, processor 160B and format_out 160C definitions. An input format definition 160A may be in the form of a memory object, a database record, a binary or text file, an executable or non executable data structure. The processing engine 170 may similarly consist of a corresponding format_in 170A, processor 170B and format_out processing 170C. Thus, when a measurement object 144 is processed by the processing engine 170, the processing can include the functions of format_in 170A, processor 170B and format_out processing 170C before providing the output 180.

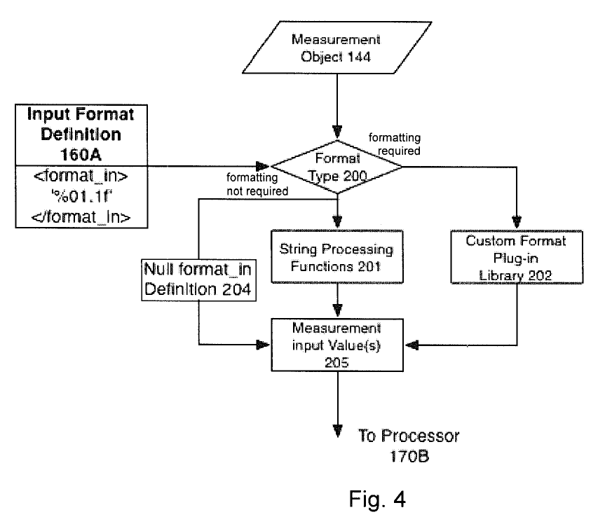

With reference to FIG. 4, a block diagram of the processing of the input format definition 170A for a Measurement Object 144 is disclosed. An input format definition 160A is evaluated for format type 200 to determine if any simple string processing functions 201 indicate that format processing is required. If format processing is required, custom format processing libraries 202 are be used. Alternatively, if no format processing is required, a null format-in definition 204 is executed 204. The measurement input value 205 processes the measurement object 144 and the measurement input value 205 is forwarded to the processor 170B.

Examples of input format definitions include, but are not limited to simple string to value conversions such as converting “5.5 meters” to a value of 5.5 with the unit ID for meters, or for custom processing an input of 3 feet 4½ inches into a value of 3.375 with the unit ID for inches. An input may result in more than one output value such as 120/80 blood pressure may be format converted into both systolic and diastolic blood pressure measurements with unit ID for mmHg. Alternatively two input values of 120 mmHg and 80 mmHg for systolic and diastolic blood pressure may be joined to form one blood pressure value of 1200.800.

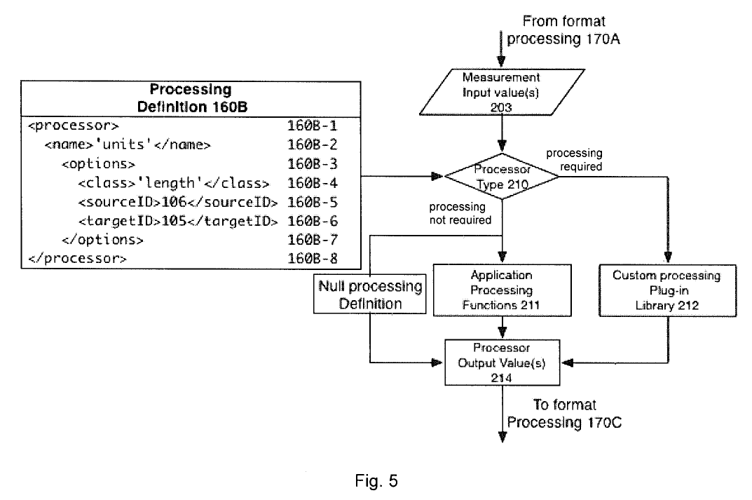

FIG. 5 illustrates a more detailed block diagram of the functionality of the processing processor 170B which receives information from the processor 160B and the measurement input value(s) 205 from the format-in processing 170A. Processing definition 160B is evaluated for processor type 210 to determine if simple application processing functions 211 exist. If application processing is required, the measurement input value(s) can be processed by the custom processing plug-in library 212. Alternatively, if no processing functions are required, a null processing definition 213 can be applied. An example of processor definitions include, but are not limited to ordinary unit conversions by execution of a ‘units’ conversion object 160B-2 of class ‘length’ 160B-4 and a source ID of 106 160B-5 and a target ID of 105 160B-6.

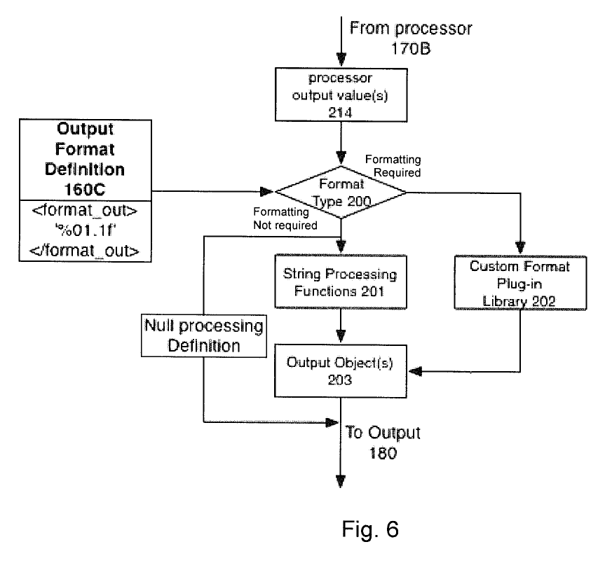

FIG. 6 illustrates a more detailed block diagram of the functionality of the format-out processing 170C. The processor output value(s) 214 are received form the processor processing 170B. The system evaluates the input format definition for format type 200 to determine if any simple string processing functions 201 indicate that format processing is required. If format processing is required, custom format processing libraries 202 are be used. Alternatively, if no format processing is required, a null format-in definition 204 is executed 204. The measurement input value 205 processes the measurement object 144 and the measurement input value 205 is forwarded to the output 180.

As discussed above, metadata that describes one embodiment of a measurement processing definition 160. The measurement processing definition can be represented as an XML document to demonstrate examples of format_in, processor, and format_out expressions. The property format_in 302 defines a floating point input value with one decimal digit such as 4.5. Processor name ‘units’ 304 defines the execution of a unit conversion object with input options 305-309 to define the units class of ‘length’ 306 with source unit ID=106 line 307 and target unit ID=105 line 308 for a conversion from kilometers to miles. Format_out 311 defines a floating point output with one decimal place.

The inventive system can be used in many different applications. In an embodiment, the present invention provides an adaptable system for tracking user information over time which provides a means for summarizing activity, monitoring changes and tracking metrics about a user. The metrics can include a plurality of interrelated quantifiable data in an infinite range of subject matter, including: health, interest, relationships, employment, entertainment, education, genealogy, etc. The processing of the data can include conversion of some or all of the data into: graphical representations, text, audio, multi-media, etc. The results of the tracking can also have a wide variety of uses, including: goal tracking, health monitoring, social networking, analysis, etc.

In an embodiment, the present invention provides a tool that can be used to help users reach their goals. The inventive system comprises a tracking program running on a server computer. A user wishing to access the tracking program will access the web site through a network such as the Internet and the server will transmit the web page information to the user. In order to provide a customized tracking interface, the tracking program may provide step by step configuration instructions to the user. These instructions are interactive and allow the user to select the metrics to be tracked and provide the personal information required to perform the tracking.

For example, if the user wishes to track weight and exercise, the user's weight is required. If a user wishes to track heart rate during exercise, the user's age might be useful so the system can warn the user when the maximum recommended beats per minute are exceeded. According to the formula, HRₘₐₓ=220−age. During this process, the user can select the desired fields for the user interface to simply data input as well as the desired output. The initial set up may be through text based inputs, buttons, voice recognition, etc. Once the user's metric tracking is configured, the user can begin inputting data.

Various examples of specific application of the present invention are in the following descriptions. In a first example, the system can track drug use and provide automated warnings and reminders. A problem with many medications is that they have so many warnings that it can be difficult to comply with the use requirements. By inputting the drugs and dosages, the system can track the usage and provide reminders about when and how to take the drugs. This can be through a text or photo message, automated phone call to a user's cell phone, audio/visual reminder on the visual display. Also when many drugs are being consumed, it can be difficult to tell the different pills from each other after they have been removed from their marked containers. A photo associated with each medication will help the users properly identify the pills by markings, color, size and shape.

The inventive system can be used to track any quantifiable metric. For example, the inventive system can be used to track a user's weight and exercise. A user can begin collecting data by inputting weight and exercise information over time. The weight is easily quantifiable by a scale and can be input with an associated time and date. In contrast, inputting and quantifying the exercise information poses a more difficult problem. The system can input information about the exercise performed such as: the type of exercise, duration, intensity, etc. Because the system is customizable, the exercise data can be as simple as “walked for 30 minutes” or “one hour of yoga.” The system can also be adjusted for users who wish to provide more detailed information. For example, a much more detailed description of the exercise can be, “ran 5 miles, first mile warm up at 10 minute pace flat grade heart rate (hr) 105 Beats per minute (BPM), 3 miles slight grade at 7.5 minute pace, hr 152 BPM, 1 mile at 8.5 minute pace downhill, hr 135 BPM.”

Once the tracking information is input, the system can be configured to perform various types of data processing. The system can produce a log of weight and exercise information which can searchable by date, so the user can select a date and review weight and exercise information. In another embodiment, the system can be configured to track the weight and exercise information over time and provide graphical results. By viewing the graphical results, the user may detect a relationship between weight lose and specific types of exercise over time. After a period of time, the user may decide to add additional data regarding diet. A new metric can be added to the tracked data and system can provide tracking of this new data field together with the weight and exercise.

A problem with many tracking systems is that they are difficult to use because the inputting of data can be tedious and time consuming. When a person grows tired of inputting data the system cannot track the data and the old data becomes obsolete. To improve the system, there are various ways to simplify the data input process, such as an improved computer user interface and the automated tracking devices.

In an embodiment, the user interface can include improved customizable data entry that pull down data entry fields which allow users to quickly input data through a graphical user interface. For example, for inputting exercise data, a menu may be displayed which allows a user to select a group of activities, walk, run, jog, bike, hike, swim, etc. People tend to perform the same types of exercise, so the activity menu can be customized to only include the user's normal activities such as walk and hike. Other input fields can be provided to input additional information such as: distance, duration and intensity level. People tend to have favorite running trails or hikes, so the interface can be customized for the user to only display normal routes. For example, a runner may like to run a loop around a lake route which is 6.23 miles long and includes 850 feet of vertical change. The menu can be customized to include this route. Information about the route can be input such as length and elevation changes along the route. Once entered and stored on the server database, so that the data is input by clicking on the item “lake route” from a listing of other normal routes or saying Lake Route into an audio input device. By simplifying the data input the user is more likely to continue to provide the required input data.

In other embodiments, the system may have tracking devices that communicate with the inventive system. For example, the user may have a monitor device that records information such as body weight and food scales, a portable GPS unit, pedometer, a heart rate monitor, timing sensor, body mass indicator (BMI), glucose sensor, blood oxygen sensor, range of motion sensor, etc. The system can communicate with these devices through wired and/or wireless connections such as RF, Bluetooth, WiFi, etc. The system can extract the data and add the information to the tracking information database. In the example above, the user may track weight and time by a signal emitted by the scale each time the user steps on the scale. The user may have a timing chip and a sensor at the front door that detects the proximity of the timing chip. When the user goes for a run, the system can automatically track the time of departure and time of return. The system may have an audio input so the user can simply say “Lake Run.” The system will associated the time for the run with this route and subtract the normal time associated with travel to the route. In other embodiments, more complex devices such as a portable GPS and heart rate monitors, can be used to detect more information such as pace, distance, vertical movement, heart rate, etc. The system can detect the difficult of the route relative to the length or simply assign a value required for the route.

A similar system can be used for diet. People may like specific types of foods and may tend to choose to eat from a small group of meals each day. Again the input menu can be configured to list the different meals: steak, chicken, eggs, pasta, ice cream, etc. and quantities, 1, 2, 3 . . . servings. The system can associate the calories per serving. Thus, a user can easily input diet information by selecting an item and quantity. The dietary information can be used to track certain health information. For example, a user may wish to be warned about excessive sea food due to a potential for mercury exposure. If the system detects that the recommended consumption of swordfish has been or will be exceeded soon, the system can display a warning indicating that swordfish and other high mercury seafood should not be consumed for a certain period of time. The user can configure the system to adjust the warnings based upon any desired parameters, such as no more than 2 servings of fish per week, 3 servings of fruits and vegetables per day, etc. Based upon recognized diet patterns, the system can provide grocery reminders or grocery shopping lists.

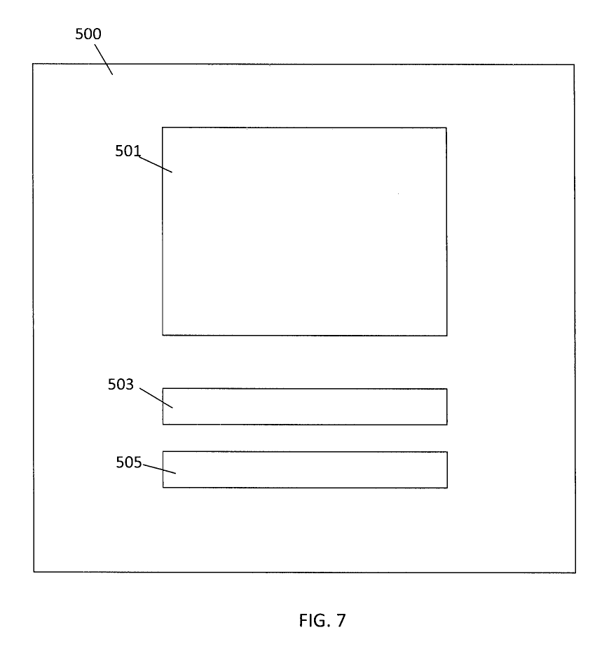

In an embodiment, the user interface can include improved customizable data entry that pull down data entry fields which allow users to quickly input data or edit stored data through a graphical user interface. With reference to FIG. 7, an embodiment of a user interface 500 is illustrated. A main area 501 is for inputting the subject information and additional areas 503, 505 for inputting tag information. In an embodiment, the subject information can be edited by adding the tag information through a first area 503 and a second area 505. The first area 503 may provide an input for the subject identification. The second area 505 may provide an input for the metric data and metric identification.

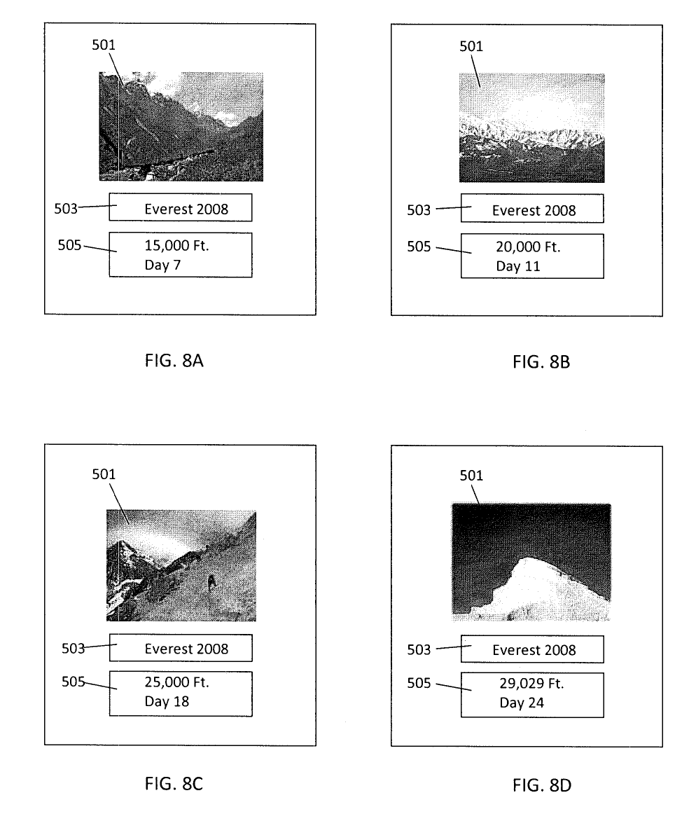

The present invention can be applied to activities. With reference to FIG. 8A-8D, subject matter is a climb of Mount Everest and the subject matter are photographs of the mountain which are input into the main area 501 of the user interface 500. The subject ID is “Everest 2008” which is input into the first additional area 503 of the user interface 500 and tagged to the photographs. The first metric data is the elevation, the first metric unit is feet, the second metric data is time and the second metric units are the number of days. All of this information is input into the second tag input area 505. In this example, the elevation and time are metric tags that are tagged to the photos at the different elevations and times. The metric data in these figures can be summarized in table 1 below:

TABLE 1

| | | First Metric | | Second Metric |
|---|---|---|---|---|
| | First Metric | Units | Second Metric | Units |
| FIG. 4A | 15,000 | Feet | 7 | Days |
| FIG. 4B | 20,000 | Feet | 11 | Days |
| FIG. 4C | 25,000 | Feet | 18 | Days |
| FIG. 4D | 29,029 | Feet | 24 | Days |

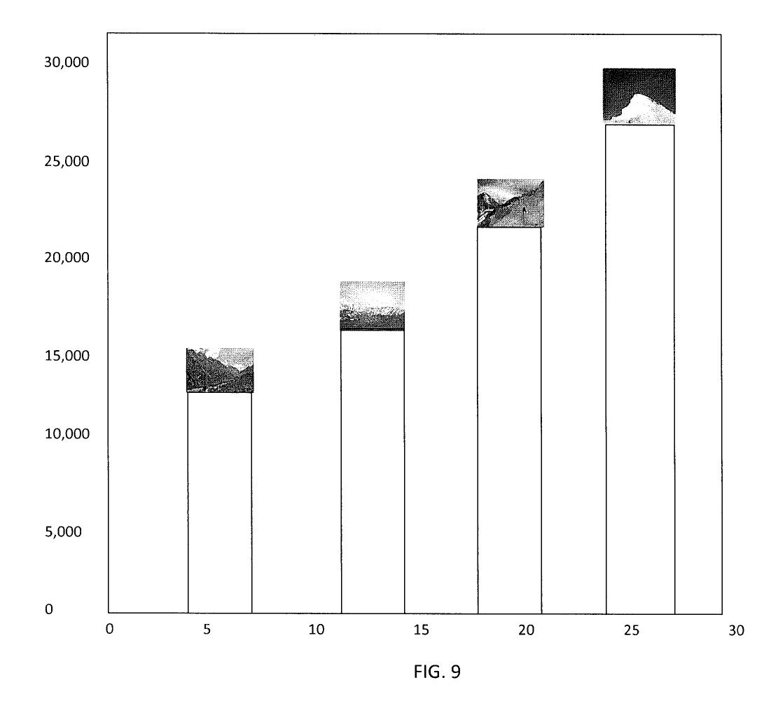

With reference to FIG. 9, a graphical display is illustrated the subject matter in a manner that utilizes the first and second metric data. In this example, the subject matter is presented in a two axis bar graph with the photos positioned at the top of each bar. The X-axis represents the days of the climb and the Y-axis represents the elevation. By utilizing the metric data, the inventive system can display the information in a manner that provides additional context which can be useful in interpreting the data.

In other embodiments, the system may have tracking devices that communicate with the inventive system for providing tag data. For example, the user may have a monitor device that records information such as a body weight and food scales, a portable GPS unit, pedometer, a heart rate monitor., timing sensor, body mass indicator (BMI), glucose sensor, blood oxygen sensor, range of motion sensor, etc. The system can communicate with these devices through wired and/or wireless connections such as RF, Bluetooth, WiFi, etc. The system can extract the data and add this information as tag data to the subject matter data. In the example above, the user may track weight and time by a signal emitted by the scale each time the user steps on the scale. The user may have a timing chip and a sensor at the front door that detects the proximity of the timing chip. When the user goes for a run, the system can automatically track the time of departure and time of return. The system may have an audio input so the user can simply say “Lake Run.” The inventive system can associated the time for the run as a tag applied to the Lake Run route.

In other embodiments, more complex devices such as portable GPS and heart rate units can be used to detect more information such as: location, pace, distance travelled, vertical movement, heart rate monitors, etc. The system can detect the difficult of the route relative to the length or simply assign a value required for the route. Again, all of this information can be applied as tags to the subject matter.

While the inventive system has been described as providing metric tags to information, it is also possible to tag information with non-metric tags in the manner described above. However, since the non-metric data cannot be quantified easily, the processing of the information with the non-metric data may not be possible as described above.

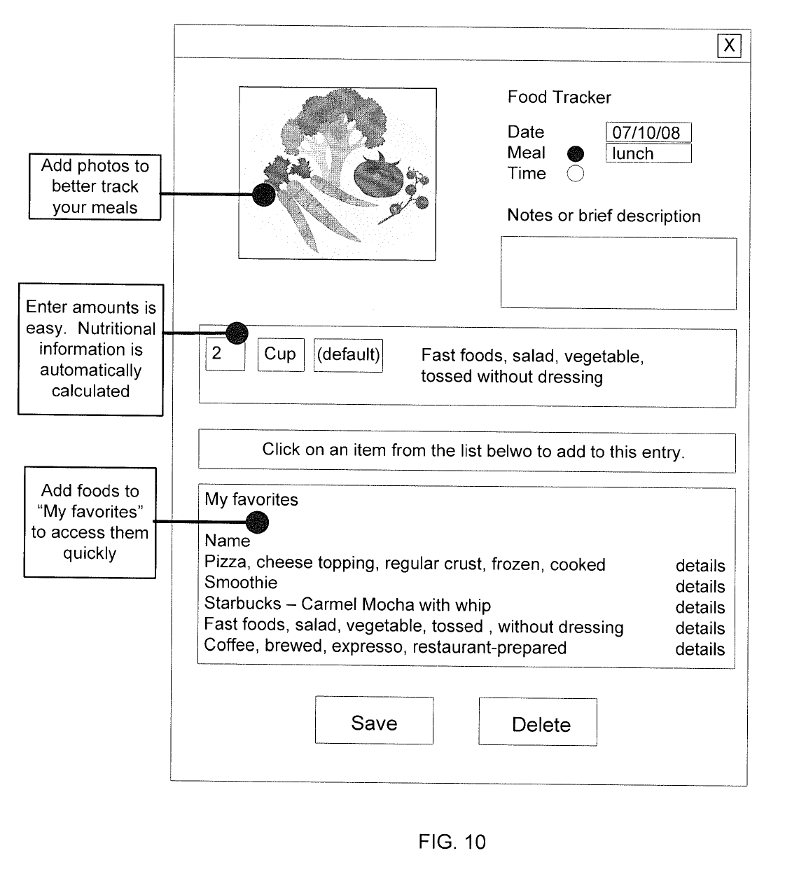

The inventive tracking system can be useful for various applications. Several examples will be described. A person may want to track food consumption. In order to do so, a food metric is accessed and the different meals and snacks consumed by the user are input. With reference to FIG. 10, a food tracker input screen 700 can display the date, time or meal 705. The user can then specify type of food being consumed and the quantity being consumed 707. If the person has favorite foods that he or she tends to eat often, these foods can be added to a quick access list 711 that allows the food description to be input by clicking on the food item. When the food is properly input, the user can click on save 713 to save the food data into the tracking system.

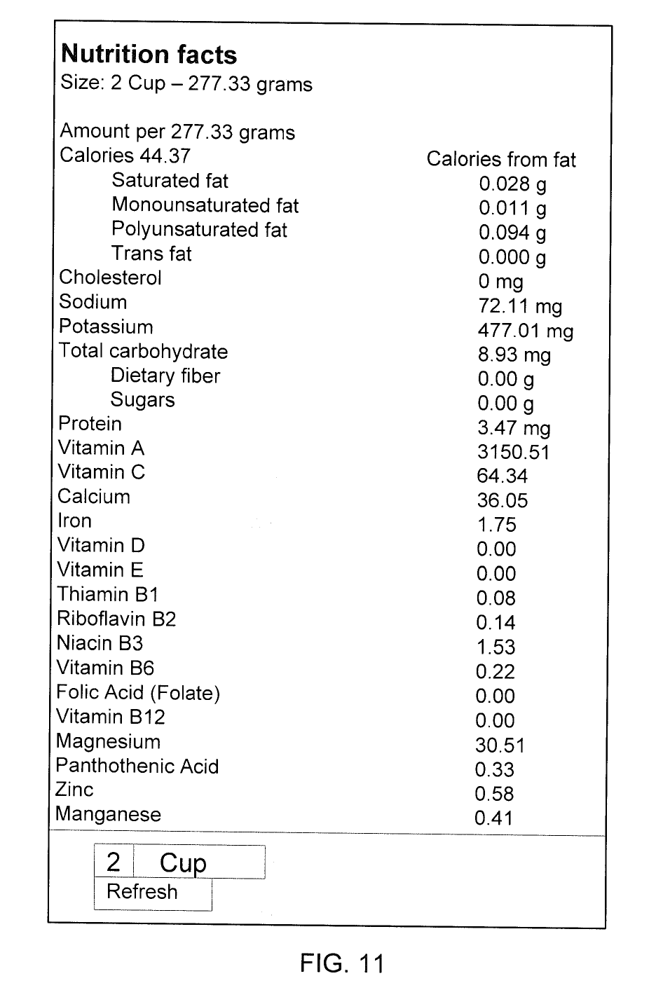

With reference to FIG. 11, if the user clicks on the details button for the food item, a listing of nutritional facts based upon the quantity is listed. The calculation is performed by multiplying the quantity by the quantity per volume for: calories, fat, cholesterol, sodium, potassium, carbohydrates, protein, Vitamin A, Vitamin C, Calcium, Iron, Vitamin D Vitamin E, Thiamin, Riboflavin, Niacin, Vitamin B6, Folic Acid, Vitamin B 12, Magnesium Pantothenic Acid, Zinc and Manganese. By changing the quantity 721, the quantities for each of the components will change.

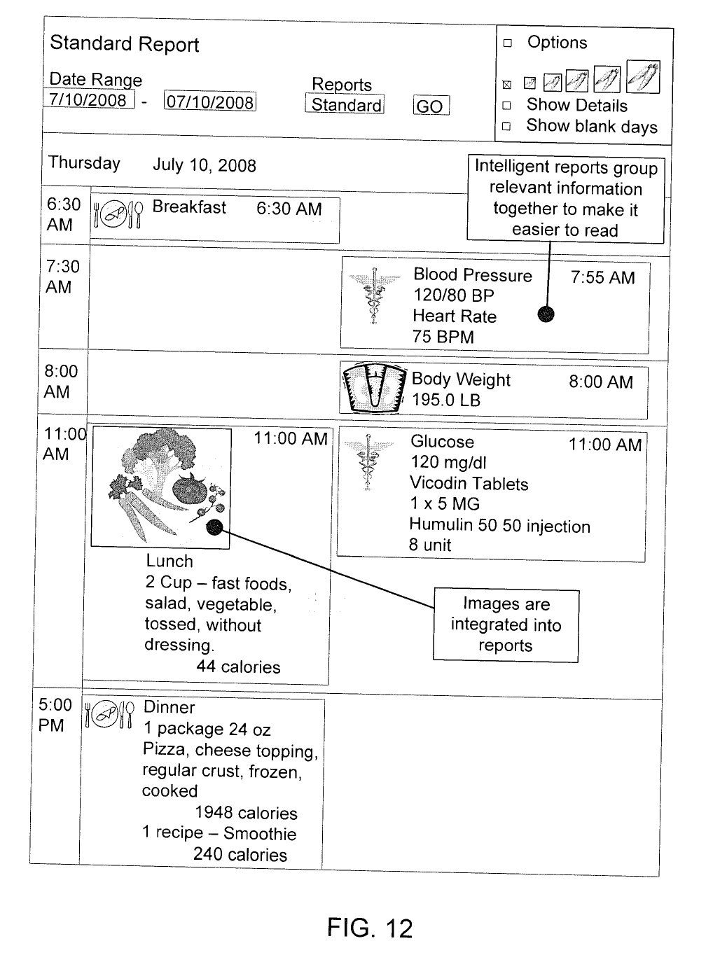

With reference to FIG. 12, when the user requests a report, the system can produce a time based chart that indicates the tracked subjects for the day which includes food consumed. In this example, breakfast at 6:30, lunch is at 11 AM and dinner was at 5 PM. Descriptions of the foods are also listed for each meal. The report can also indicate the blood pressure measurement taken at 7:59 AM, body weight measurement taken at 8:00 AM, glucose levels and medication metrics taken at 11:00 AM. The reports can be customized to include other information that the user wishes to track or other time frames. In order to minimize errors, the system can track normal ranges of values. For example, resting heart rate will normally range between 60 and 100 BPM for people between the ages of 6 and over. Newborns have a normal heart rate of 120 BPM. In an embodiment, the tracking system will identify data that is outside the normal range and display a warning indicating unusual data. The user can then correct the data or ignore the warning.

In many applications, the tagging feature of the inventive tracking system can provide useful information which allows better analysis of changes over time. For example, patient may have invasive surgery for a knee reconstruction. After the surgery, the patient's knee is swollen and a large post operation wound that is closed with stitches. As a result of the surgery, the range of motion is reduced. The patient goes to physical therapy and the progress of the recovery process can be measured based upon the range of mobility, pain, ability to support weight, size of the swelling and the size of the wound over time. The tracking program can also monitor: medication (types and quantities), sleep, types of physical therapy utilized and leg strength over time. In order to accurately monitor the healing of the wound, photographs of the wound can be taken and tagged to the size of the wound data. The tracking system can produce reports on the progress that can include graphical data illustrating the changes over time and the medication and therapy used throughout the recovery process. The photos can be integrated into the graphical data for easy review by a physician. Based upon the report results, it may be possible to determine the most effective medications and physical therapy activities and determine the proper time to remove the stitches alter and increase the physical capabilities of the patient. Since the reports can be easily customized and transmitted to others, remote monitoring of the progress is greatly simplified. The reports can be customized to the physician's requirements and accessed at any time.

In another example, a user can track the progress in learning a musical instrument. The data tracked can include time and hours of practice. The practice data can then be tagged with audio recordings of the practice sessions. The system can compare the recorded data to the sheet music to determine the accuracy of the notes and timing. The system provides a rating of a recording based upon fundamental accuracy and the recordings can be sent to others who can provide ratings. The ratings can be saved by the system and hopefully a progressive improvement can be quantified on a report produced by the system. The user can access the report and prior recording tags at any time in the future.

In another embodiment, more tangible information such as vehicle performance can be tracked. A user can input metric information such as miles travelled, gas consumed, miles travelled per gallon, commute durations, etc. Based upon the input information, the system can track variables that may alter the gas mileage including: season, weather and road conditions. Since many people have portable web accessible mobile devices, data can be input while at gas stations

A benefit of tracking metrics is that the data can be analyzed and in some instances the cause and effect of actions and reactions can be determined. This can be particularly important with medication since many medications have warnings about use and side effects, such as do not take if you have certain physical conditions: overweight, high cholesterol, pregnant, etc. It can be unsafe to drive or perform motor activity after taking certain drugs like anti-depressants. Thus, similar potentially dangerous activities should also not be performed, such as performing an active job around moving machine parts. These drugs may cause sleepiness and inhibit reaction times. In some cases, patients can be allergic to certain medications which can result in physical reactions such as insomnia, head aches. Certain medications should not be taken simultaneously and can cause reactions that would not happen if they were taken individually.

Because the inventive tracking system can monitor all related aspects of a user's life, the system can be used to monitor reactions to medications and medication compatibility. In an embodiment, if a user inputs incompatible medications, the system will issue a warning indicating that the medications cannot be safely taken simultaneously and advising the user against continuing to take both medications. Similarly, the system will issue warnings if the user inputs or normally performs activities that are not recommended while on the medication. When the user inputs the medication, the system will check all prior activities and will warn the user against performing any potentially problematic activities. If the user inputs reactions that are symptomatic of known reactions to certain medications, the system will also issue warnings. For example, if the user is taking a medication that has the side effect of causing drowsiness and the user soon inputs a low energy level, the system may notify the user that the lack of energy may be caused by the medication. Similarly, the tracking program can quantify the efficacy of medications by tracking the aspects that the medication is used for. For example, if a user has an improved range of motion after taking arthritis medication, the system may issue a report indicating the patient's improvement and the relationship to the dosage of the medication. In an embodiment, the medications, desired effect and side effect information are stored in a database coupled to the server computer.

Similar notifications can be provided for various different applications of the tracking program. For example, a user may input goals such as weight loss, activity speed, work or school progress. The system can monitor these metrics of interest and also the surrounding activities. After a sufficient quantity of information is gathered, the system can be used to illustrate relationships between input metrics. For example, the tracking system can determine that higher performance is achieved when a breakfast that includes a particular food is consumed on the day of the activity. While many relationships are predicable, it may be possible to determine unexpected results using the tracking system.

By simplifying the data input processes, the system is more likely to be used and the data generated by the program will be more accurate. In an embodiment, the user of the inventive system must subscribe to a service that provides the service and tools described above. The subscription may require payment for unlimited use or payment per area of interest. The subscription fee may be based upon use annually, monthly, any predetermined time period. Alternatively, use of the web site may be free and revenues may be generated by advertisements placed on the web site.

As illustrated in the figure of the present application and described herein, aspects of the present invention may be implemented on one or more computers executing software instructions. According to one embodiment of the present invention, server and client computer systems transmit and receive data over a computer network or standard telephone or cell phone lines. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the downloaded instructions may be directly supported by the CPU. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, or to any particular source for the instructions executed by the server or client computers.

Although the processes and methods herein have been illustrated with a specific flow chart, it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD ROM, or transmitted over a network, and executed by a processor.

Although the present invention has been described above in terms of specific embodiments, it is anticipated that alterations and modifications to this invention will be apparent to those skilled in the art and may be practiced within the scope and equivalents of the appended claims. More than one computer may be used, such as by using multiple computers in a parallel or load-sharing arrangement or distributing tasks across multiple computers such that, as a whole, they perform the functions of the components identified herein; i.e. they take the place of a single computer. Various functions described above may be performed by a single process or groups of processes, on a single computer or distributed over several computers. Processes may invoke other processes to handle certain tasks. A single storage device may be used, or several may be used to take the place of a single storage device. The present embodiments are to be considered as illustrative and not restrictive, and the invention is not to be limited to the details given herein. It is therefore intended that the disclosure and following claims be interpreted as covering all such alterations and modifications as fall within the true spirit and scope of the invention.

What is claimed is:

1. A method for dynamic configuration of measurement metrics for a user, comprising:
providing a server computer, a client computer and a network coupled to the server computer and the client computers;
inputting first input metric values for a health subject over a time period through the input device;
inputting second input metric values for an activity subject over the time period through the input device;
correlating the first input metric and the second input metric with metric definitions by the server;
creating an input format definition logic based upon the first input metric and the second input metric and metric subjects by the server;
creating a processing logic based upon the first input metric, the second input metric and the metric subjects by the server;
creating an output processing logic based upon the first input metric, the second input metric and the metric subjects by the server; and
transmitting a report from the server to the client computer that includes changes in the first input metric values for the health subject and changes in the second input metric values for the activity subject over the time period.

2. The method of claim 1 wherein the health subject includes one or more of: weight, energy level, illness and medical condition.

3. The method of claim 1 wherein the first input metric values for the health subject are tagged with photos of the user and the creating the output processing logic is based upon the photos tagged to the first input metric values.

4. The method of claim 3 wherein the transmitting the report from the server to the client computer includes the photos tagged to the first input metric values.

5. The method of claim 1 wherein the activity subject includes one or more of: exercise, meditation, sex, sleep, smoking and TV viewing.

6. The method of claim 1 wherein the first input metric values for the health subject are tagged with photos of the activity and the creating the output processing logic is based upon the photos tagged to the first input metric values.

7. The method of claim 6 wherein the transmitting the report from the server to the client computer includes the photos tagged to the first input metric values.

8. A method for dynamic configuration of measurement metrics for a user, comprising:
providing a server computer, a client computer and a network coupled to the server computer and the client computers;
inputting first input metric values for a first subject over a time period through the input device;
inputting second input metric values for an second subject over the time period through the input device;
correlating the first input metric and the second input metric with metric definitions by the server;
creating an input format definition logic based upon the first input metric and the second input metric and metric subjects by the server;
creating a processing logic based upon the first input metric, the second input metric and the metric subjects by the server;
creating an output processing logic based upon the first input metric, the second input metric and the metric subjects by the server; and
transmitting a report from the server to the client computer that includes changes in the first input metric values for the health subject and changes in the second input metric values for the activity subject over the time period.

9. The method of claim 8 wherein the first input metric values for the first subject are tagged with photos of the user and the creating the output processing logic is based upon the photos tagged to the first input metric values.

10. The method of claim 9 wherein the transmitting the report from the server to the client computer includes the photos tagged to the first input metric values.

11. The method of claim 9 wherein the photos tagged to the first input metric values provide additional metric data about the first input metric values.

12. The method of claim 9 wherein the second input metric values for the second subject are tagged with photos of the second subject and the creating the output processing logic is based upon the photos tagged to the second input metric values.

13. The method of claim 11 wherein the transmitting the report from the server to the client computer includes the photos tagged to the second input metric values.

14. The method of claim 13 wherein the photos tagged to the second input metric values provide additional metric data about the second input metric values.

15. The method of claim 8 wherein the first input metric values for the first subject are tagged with audio recordings of the user and the creating the output processing logic is based upon the audio recordings tagged to the first input metric values.

16. The method of claim 9 wherein the transmitting the report from the server to the client computer includes the audio recordings of the user tagged to the first input metric values.

17. The method of claim 16 wherein the audio recordings tagged to the first input metric values provide additional metric data about the first input metric values.

18. The method of claim 8 wherein the second input metric values for the second subject are tagged with audio recordings of the second subject and the creating the output processing logic is based upon the audio recordings tagged to the second input metric values.

19. The method of claim 18 wherein the transmitting the report from the server to the client computer includes the audio recordings tagged to the second input metric values.

20. The method of claim 19 wherein the audio recordings tagged to the first input metric values provide additional metric data about the first input metric values.
